(19) United States
(12) Patent Application Publication
(10) Pub. No.: US 2025/0294361 A1
(43) Pub. Date: Sep. 18, 2025

(54) TRUST ESTABLISHMENT IN WIRELESS NETWORKS

(71) Applicant: QUALCOMM Incorporated, San Diego, CA (US)

(72) Inventors: Soo Bum LEE, San Diego, CA (US); Gavin Bernard HORN, La Jolla, CA (US)

(21) Appl. No.: 18/608,546

(22) Filed: Mar. 18, 2024

(51) Int. Cl. H04W 12/37; H04W 12/06

(52) U.S. Cl. CPC H04W 12/37; H04W 12/06

(57) ABSTRACT

Various aspects of the present disclosure generally relate to wireless communication. In some aspects, a security service device may receive, from at least one of a device or a service, attestation information that includes verifiable information regarding a state of the device or a state of the service. The security service device may generate an attestation result indicating whether the attestation information satisfies an appraisal condition. The security service device may receive a request for the attestation result. The security service device may provide the attestation result in accordance with the request. Numerous other aspects are described.

### FIELD OF THE DISCLOSURE

Aspects of the present disclosure generally relate to wireless communication and specifically relate to techniques, apparatuses, and methods for trust establishment in wireless networks.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a security service device includes receiving, from at least one of a device or a service, attestation information that includes verifiable information regarding a state of the device or a state of the service; generating an attestation result indicating whether the attestation information satisfies an appraisal condition; receiving a request for the attestation result; and providing the attestation result in accordance with the request.

In some aspects, a method of wireless communication performed by an attester device includes receiving, from a service, a request for attestation information that includes verifiable information regarding a state of the attester device; and transmitting the attestation information in accordance with the request.

In some aspects, an apparatus for wireless communication at a security service device includes one or more memories; and one or more processors, coupled to the one or more memories, configured to cause the security service device to: receive, from at least one of a device or a service, attestation information that includes verifiable information regarding a state of the device or a state of the service; generate an attestation result indicating whether the attestation information satisfies an appraisal condition; receive a request for the attestation result; and provide the attestation result in accordance with the request.

In some aspects, an apparatus for wireless communication at an attester device includes one or more memories; and one or more processors, coupled to the one or more memories, configured to cause the attester device to: receive, from a service, a request for attestation information that includes verifiable information regarding a state of the attester device; and transmit the attestation information in accordance with the request.

In some aspects, a non-transitory computer-readable medium storing a set of instructions for wireless communication includes one or more instructions that, when executed by one or more processors of a security service device, cause the security service device to: receive, from at least one of a device or a service, attestation information that includes verifiable information regarding a state of the device or a state of the service; generate an attestation result indicating whether the attestation information satisfies an appraisal condition; receive a request for the attestation result; and provide the attestation result in accordance with the request.

In some aspects, a non-transitory computer-readable medium storing a set of instructions for wireless communication includes one or more instructions that, when executed by one or more processors of an attester device, cause the attester device to: receive, from a service, a request for attestation information that includes verifiable information regarding a state of the attester device; and transmit the attestation information in accordance with the request.

In some aspects, an apparatus for wireless communication includes means for receiving, from at least one of a device or a service, attestation information that includes verifiable information regarding a state of the device or a state of the service; means for generating an attestation result indicating whether the attestation information satisfies an appraisal condition; means for receiving a request for the attestation result; and means for providing the attestation result in accordance with the request.

In some aspects, an apparatus for wireless communication includes means for receiving, from a service, a request for attestation information that includes verifiable information regarding a state of the attester device; and means for transmitting the attestation information in accordance with the request.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram of an example of a service-based architecture, in accordance with the present disclosure.

FIG. 5 is a diagram illustrating an example of a trust establishment flow for a security service device in a wireless network, in accordance with the present disclosure.

FIG. 6 is a diagram illustrating an example of signaling associated with remote attestation to establish trust in a wireless network, in accordance with the present disclosure.

FIG. 7 is a diagram illustrating an example of signaling associated with remote trust in a wireless network, in accordance with the present disclosure.

FIG. 8 is a diagram illustrating an example of on-demand mutual attestation, in accordance with the present disclosure.

FIG. 9 is a diagram illustrating an example of a remote attestation procedures (RATS) architecture, in accordance with the present disclosure.

FIG. 10 is a diagram illustrating an example process performed, for example, at a security service device or an apparatus of a security service device, in accordance with the present disclosure.

FIG. 11 is a diagram illustrating an example process performed, for example, at an attester device or an apparatus of an attester device, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless networks may perform subscription authentication according to a subscriber identity module (SIM) credential of a device accessing the wireless network (or a service of the wireless network). Thus, so long as a device has obtained a valid subscription credential (provisioned by a mobile network operator (MNO)) of the device) for a subscription profile of the device, the device can access the network and services using the subscription profile. Furthermore, reporting of an International Mobile Equipment Identity (IMEI) may not fully authenticate the device and accordingly may not be used to establish trust for the device since a fake IMEI can be configured and reported by the device. This may lead to a situation where compromised user equipments (UEs) can launch attacks against the network, a spoofed device with a valid SIM is used for voice phishing attacks, or gray-market or cloned devices are used to circumvent standards-compliance certification. Notably, in some examples, authentication alone (which refers to verifying the identity of a device, or more specifically whether the device is the authentic device that the device claims to be), may not fully mitigate these issues.

Aspects of the present disclosure relate generally to establishment of trust in a wireless network. Some aspects more specifically relate to establishing trust by facilitating attestation (such as remote attestation) of a device to a security service device. “Attestation” is a procedure in which a relying party (e.g., a service provider) assesses the trustworthiness of a remote peer entity (such as a device or human) based on evidence provided by or associated with the remote peer. In aspects described herein, the relying party may include the security service device and/or a service or device (such as a UE or network node) performing authentication and evaluating integrity of the remote peer entity. In aspects described herein, the remote peer entity may be the device.

Attestation may provide benefits in a wireless network which cannot be achieved by authentication alone. Remote attestation may provide for identification of whether the device is in a desired or expected state, thereby mitigating or eliminating the occurrence of compromised UEs launching attacks, device identity spoofing, or circumvention of standards-compliance certification.

However, remote attestation may provide certain challenges in a wireless network. For example, it may be difficult to scale remote attestation to a scale that is feasible for network-wide implementation, because of the variety of types of devices, the variety of versions of software that may operate on devices, and roaming scenarios that may arise.

Aspects described herein provide attestation by the device (such as a UE) with the security service device as a root of trust for the attestation. Additionally, or alternatively, a network node may perform attestation with the security service device. In some aspects, this attestation may be performed in addition to (e.g., in connection with) authentication. Furthermore, aspects described herein provide semi-dynamic or dynamic attestation, as well as mutual attestation.

Aspects of the present disclosure may be used to provide one or more of the following potential advantages. By using a security service device as a root of trust for attestation of devices and services, the security service device may provide scalable attestation across multiple networks, thereby reducing the occurrence of the difficulties described above. By performing attestation in addition to (e.g., in connection with) authentication, reduced attestation and verification overhead is provided relative to performing attestation separately from authentication. Semi-dynamic attestation may provide scalability by allowing the security service device to provide an attestation result previously obtained by the security service device for a length of time, thereby reducing signaling overhead. Dynamic attestation (sometimes referred to as on-demand attestation) may support various use cases such as mutual attestation, increasing the flexibility of network operation and attestation.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

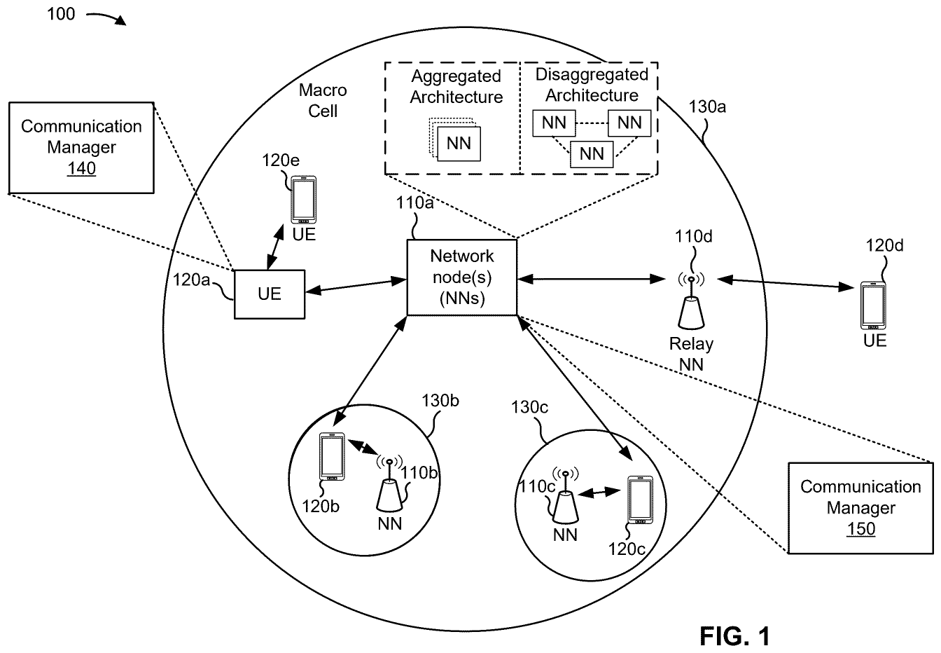

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or cMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the attester device may include a communication manager 140 or 150. As described in more detail elsewhere herein, the communication manager 140 or 150 may receive, from a service, a request for attestation information that includes verifiable information regarding a state of the attester device; and transmit the attestation information in accordance with the request. Additionally, or alternatively, the communication manager 140 or 150 may perform one or more other operations described herein.

As indicated above, FIG. 1 is provided as an example. Other examples may differ from what is described with regard to FIG. 1.

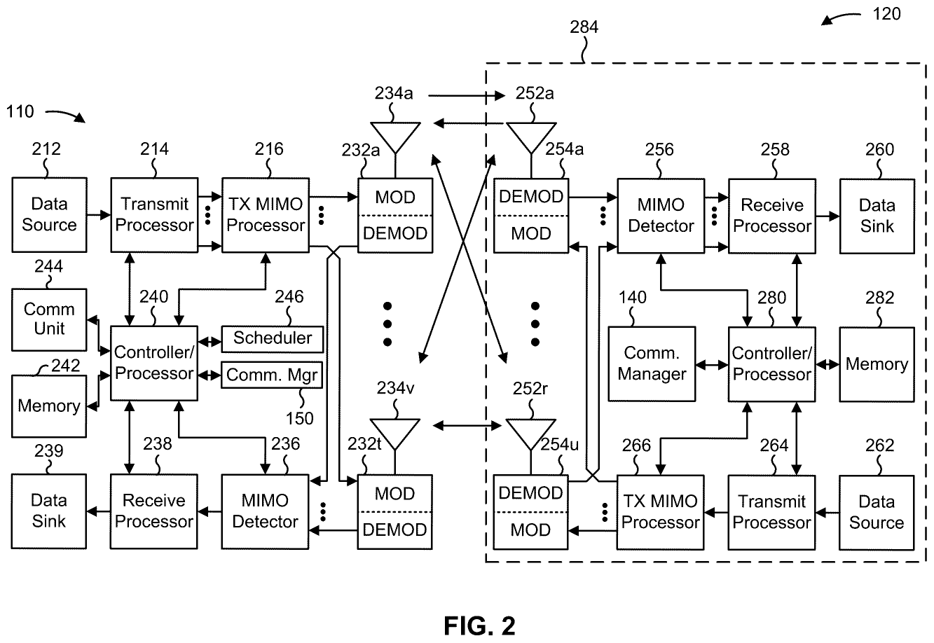

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

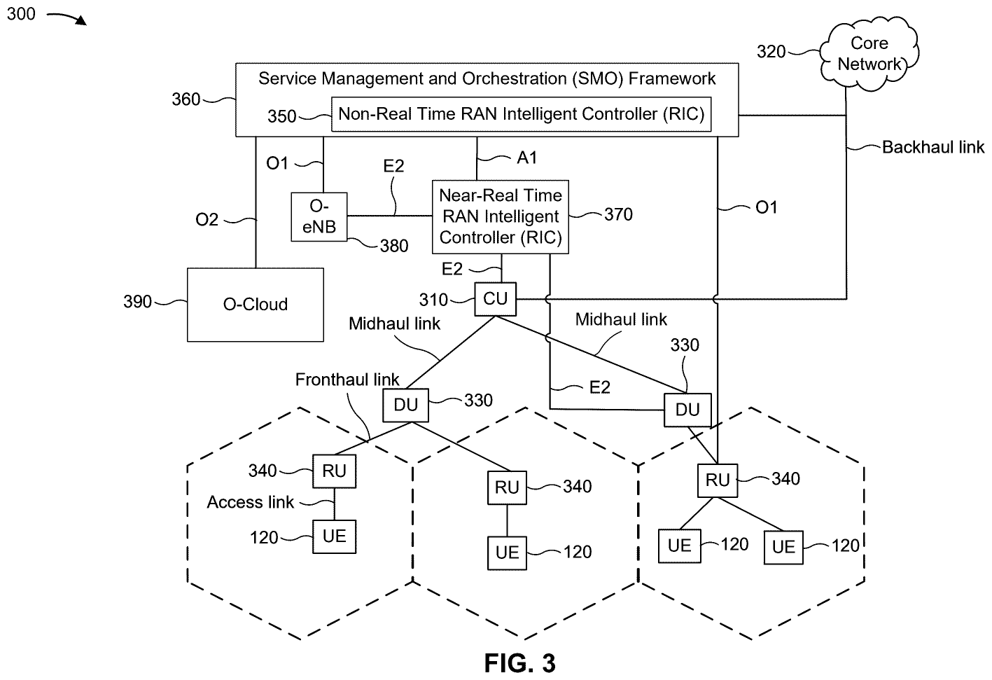

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

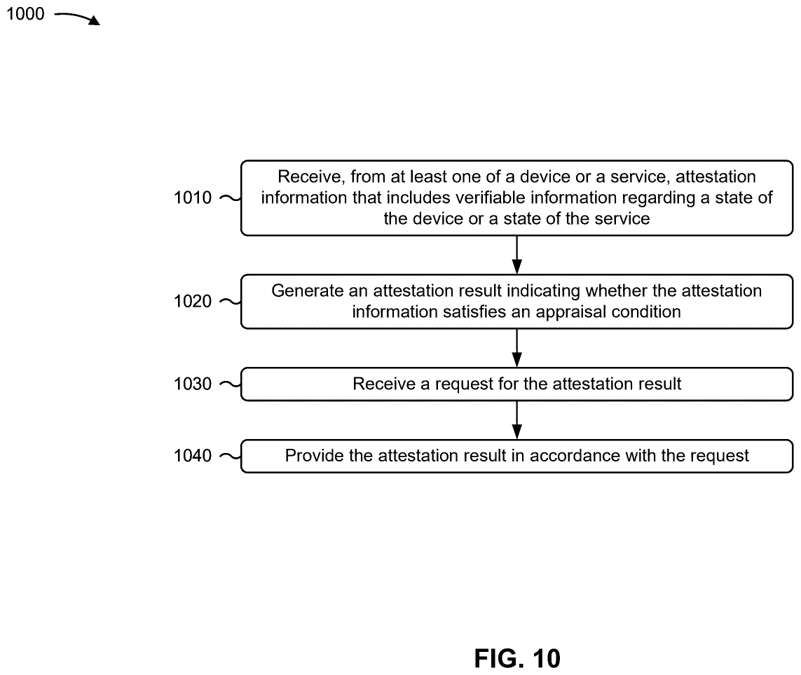

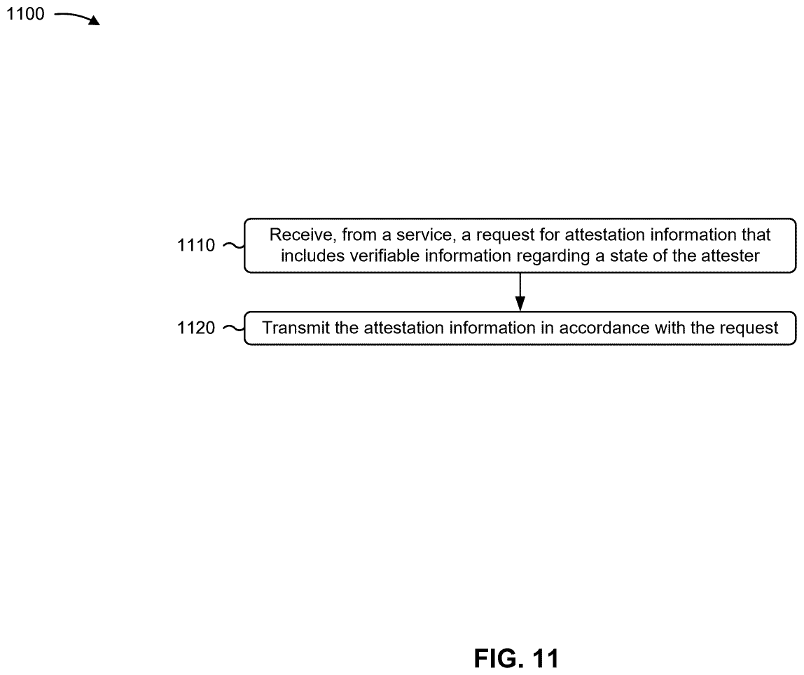

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with remote attestation, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples. In some aspects, an attester device (such as UE 120, network node 110, a DU, an RU, or a service) includes means for receiving, from a service, a request for attestation information that includes verifiable information regarding a state of the attester device; and/or means for transmitting the attestation information in accordance with the request. In some aspects, the means for the attester device to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246. In some aspects, the means for the attester device to perform operations described herein may include, for example, one or more of communication manager 140, antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

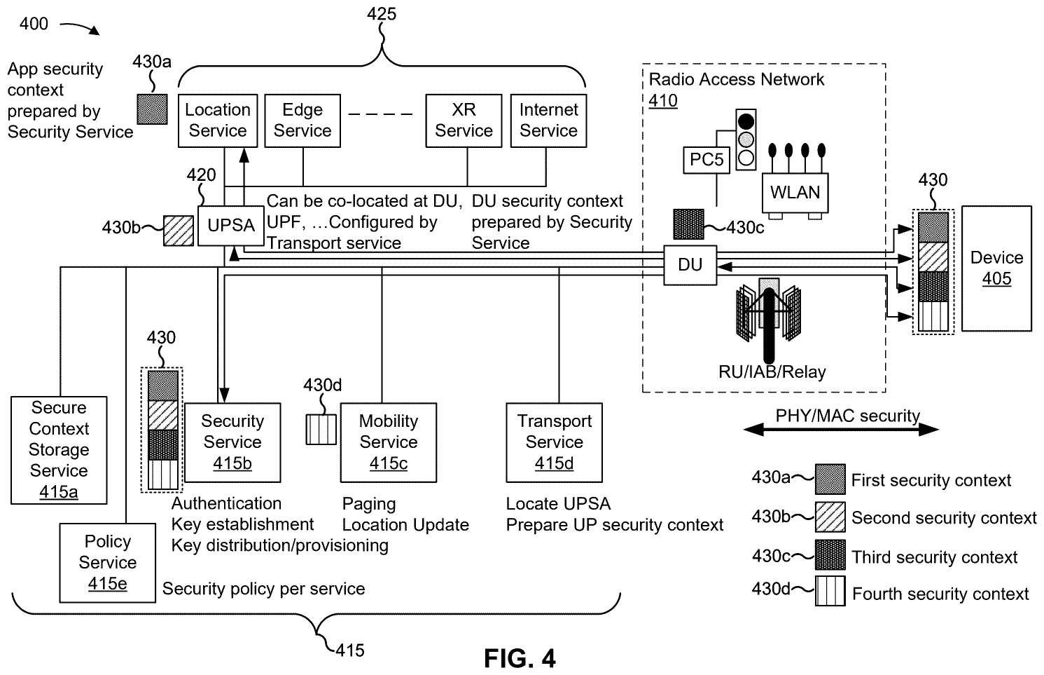

FIG. 4 is a diagram of an example 400 of a service-based architecture, in accordance with the present disclosure. As shown, the example 400 may include a device 405 (e.g., a UE 120, a network node 110, or another device capable of communicating via a RAN), a RAN 410, a set of horizontal service devices 415, a user plane security anchor (UPSA) 420, and a set of vertical service devices 425. Reference to a service can also refer to a service device on or in connection with which the service is implemented.

The proliferation of cloud networks facilitates deployment of a service-based architecture for wireless networks, such as 6G networks. For example, a cloud-native platform may enable a merger of core network (CN) services (e.g., functions) and radio access network (RAN) services (e.g., functions), which may simplify protocols and reduce duplication of services across the CN and the RAN. A service-based architecture may include horizontal service devices 415 (which may refer to or include essential or common services for network access), a RAN 410, and a set of vertical service devices 425 (which may be referred to or include applications). A horizontal service device 415 or a vertical service device 425 may be configured with an interface such as an application programming interface (API), and may be implemented by a service server, which may be a device or a cloud implementation (e.g., a virtual machine). A vertical service device 425 or a node of the RAN 410 may interact with a horizontal service device 415 (such as horizontal service device 415a, 415b, 415c, 415d, or 415e) using the interface. A service-based architecture may differ from a CN-based architecture in that services or functions related to a given functionality (such as mobility) may be deployed and/or performed by a single independent horizontal service device 415 rather than being integrated into a CN function (e.g., an access and mobility management function (AMF), a user plane function (UPF), a session management function (SMF), or another core network function) and a RAN node. For example, rather than a CN function and a RAN node communicating with one another to execute a mobility operation for a UE or a DU, the DU may interface with a mobility service, which may handle selection of a target DU and configuration or other signaling related to the mobility operation.

As shown, the RAN 410 may include a DU (e.g., network node 110, DU 330), a wireless local area network node, a physical radio interface (e.g., network node 110) (illustrated, for example, as an IAB, an RU 340, or a relay), or the like. For example, the RAN 410 may include one or more gNBs. The RAN 410 may implement communication via one or more RATs, such as PC5 for sidelink communication (where PC5 may be considered part of another RAT), 4G, 5G, 6G, another RAT, or a combination thereof.

The set of horizontal service devices 415 may include, for example, a secure context storage service device 415a, a security service device 415b, a mobility service device 415c, a transport service device 415d, and/or a policy service device 415e. The secure context storage service device 415a may store contexts, such as security contexts or other forms of context, used during operation of the RAN 410, the horizontal service devices 415, or the vertical service devices 425. A context may include a set of information that is associated with a specific device or service. For example, a UE context may include a set of information and parameters associated with a specific UE. A security context, such as a user-plane security context, may include a set of security-related parameters associated with a specific device 405, a specific service device 415/425, or a combination thereof. For example, a security context may indicate security keys and/or other parameters used for secure communication between two parties in the service-based architecture.

The security service device 415b may perform operations related to maintaining a secure connection between the device 405 and one or more service devices 415/425 of the service-based architecture. For example, the security service device 415b may perform authentication of the device 405 or a service device 415/425. As another example, the security service device 415b may perform key establishment for a device 405 or service device 415/425. As another example, the security service device 415b may perform key distribution or provisioning associated with establishment or updating of security for a device 405 and/or service device 415/425. In some aspects, the security service device 415b may prepare a security context, such as a user-plane security context, for the device 405.

The mobility service device 415c may perform operations related to mobility of devices 405, such as paging, location updating, handover preparation, identification of target DUs, or the like. The transport service device 415 may locate a UPSA 420 for a device 405 and/or may prepare a user-plane security context (which may or may not include the security context described above) for the device 405.

In some examples, a device 405 may communicate with a given service device 415/425 using a security context associated with the device 405 and that service device 415/425. This is illustrated by a square with a given hatch or fill at the device 405, and a corresponding square with a given hatch or fill at the service device 415/425. In the example of FIG. 4, the device 405 is associated with a set of security contexts 430a, 430b, 430c, and 430d (collectively referred to as security contexts 430). Although the set of security contexts 430 in FIG. 4 is shown to include four security contexts, it should be understood that a greater or lesser number of security contexts may be included in the set of security contexts 430 in other examples.

For example, the device 405 may communicate with a mobility service device 415c using a security context 430d illustrated by a vertical striped fill. As another example, the device 405 may communicate with a DU of the RAN 410 using a security context 430c. As another example, the device 405 may communicate with the UPSA 420 using a security context 430b. As another example, the device 405 may communicate with the location service device 425 using a security context 430a. Furthermore, the security service device 415b may manage these security contexts 430a, 430b, 430c, 430d. Therefore, all of these security contexts 430a, 430b, 430c, and 430d (represented as squares with corresponding hatches or fills) are illustrated at the security service device 415b. Physical and MAC layer security may be provided between the device 405 and the RAN 410.

The horizontal service devices 415 may perform network functions, which may be used across vertical service devices 425. For example, the vertical service devices 425 (which may include, for example, a location service, a voice service, an edge service, an XR service, an Internet service, or the like) may correspond to applications which a device 405 may communicate with. The horizontal service devices 415 may provide network functions to support communication between the device 405 and the vertical service devices 425. Thus, the horizontal service devices 415 may be referred to as horizontal services, and the vertical service devices 425 may be referred to as vertical services. The UPSA 420 may handle user-plane security service device functions, such as key storage for a visited network or service device 425.

As indicated above, FIG. 4 is provided as an example. Other examples may differ from what is described with regard to FIG. 4.

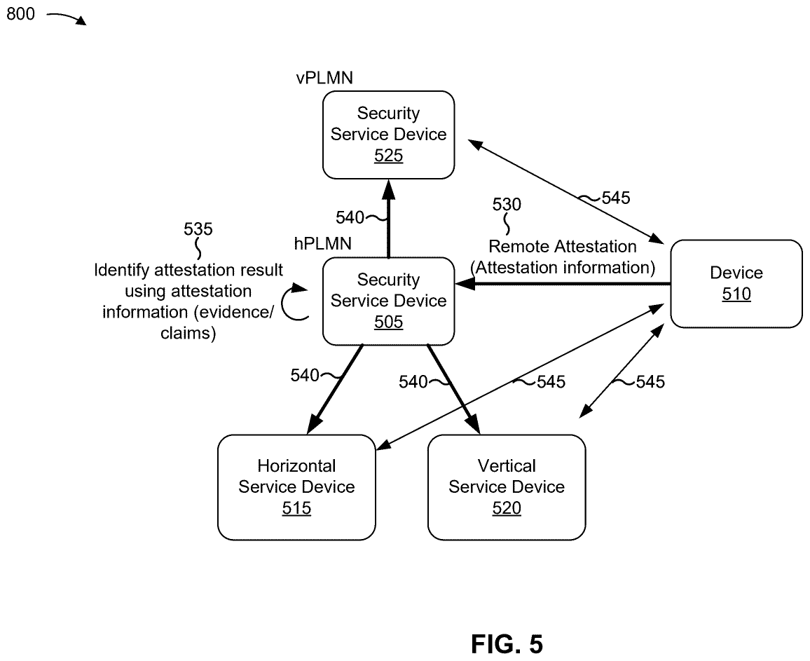

FIG. 5 is a diagram illustrating an example 500 of a trust establishment flow for a security service device in a wireless network, in accordance with the present disclosure. Example 500 includes a security service device 505 (e.g., security service device 415b), a device 510 (e.g., device 405, a UE 120, a network node 110, or another device capable of communicating via a RAN), and at least one of a horizontal service device 515 (e.g., horizontal service device 415), a vertical service device 520 (e.g., vertical service device 425), or a security service device 525 associated with a visited public land mobile network (PLMN). A PLMN is a network of a particular operator in a particular country identified by a PLMN Identifier or PLMN ID. In this context, a PLMN refers to a network operating with a given RAT (e.g., 6G). A home PLMN (hPLMN) may correspond to a network to which the device 510 is subscribed and associated with a first operator or service provider. A visited PLMN (vPLMN) may correspond to a network which the device 510 is roaming and currently registered to, and which may be provided by a different operator or service provider than the hPLMN. Reference to a given PLMN should be understood to refer to a network identified by the given PLMN.

Aspects described herein relate to establishment of trust in a wireless network by facilitating attestation (such as remote attestation) of the device 510 to the security service device 505. “Attestation” is a procedure in which a relying party (e.g., a service provider) assesses the trustworthiness of a remote peer entity (such as a device or human) based on evidence provided by or associated with the remote peer. In aspects described herein, the relying party may include the security service device 505 and/or a service (such as the horizontal service device 515, the vertical service device 520, or the security service device 525) or device (such as a UE or network node) performing authentication and evaluating attestation and/or a state of the remote peer entity. In aspects described herein, the remote peer entity may be the device 510.

Attestation may be distinct from authentication. For example, attestation may involve a device 510 providing information (referred to as evidence) regarding a current state of the device 510 to the security service device 505. Attestation may enable the security service device 505 (or a verifying party external to the security service device 505) to determine whether the device 510 is in a desired or expected state, thereby establishing whether the device 510 can be trusted. Authentication, on the other hand, generally involves verifying the identity of device 510 (that is, identifying whether the device 510 is the authentic device that the device 510 claims to be).

Attestation may provide benefits in a wireless network which cannot be achieved by authentication alone. For example, some wireless networks may perform subscription authentication according to a subscriber identity module (SIM) credential of the device 510. Thus, so long as a device 510 has obtained a valid subscription credential (provisioned by a mobile network operator (MNO)) of the device 510) for a subscription profile of the device 510, the device 510 can access the network and services (such as horizontal services 515 or vertical services 520) using the subscription profile. Furthermore, reporting of an International Mobile Equipment Identity (IMEI) may not fully authenticate the device 510 and accordingly may not be used to establish trust for the device since a fake IMEI can be configured and reported by the device 510. This may lead to a situation where compromised UEs can launch attacks against the network, a spoofed device with a valid SIM is used for voice phishing attacks, or gray-market or cloned devices are used to circumvent standards-compliance certification. Remote attestation may provide for identification of whether the device 510 is in a desired or expected state, thereby mitigating or eliminating the occurrence of compromised UEs launching attacks, device identity spoofing, or circumvention of standards-compliance certification.

However, remote attestation may provide certain challenges in a wireless network. For example, it may be difficult to scale remote attestation to a scale that is feasible for network-wide implementation, because of the variety of types of devices, the variety of versions of software that may operate on devices, and roaming scenarios (involving an hPLMN and a vPLMN) that may arise.

Aspects described herein provide attestation by the device 510 with the security service device 505 as a root of trust for the attestation. Additionally, or alternatively, a network node may perform attestation with the security service device 505. A root of trust may be an entity that provides an attestation result for the device 510 or network node to other entities such that the other entities can establish trust of the device 510 or network node. For example, the other entities may include one or more of the device 510, the horizontal service device 515, the vertical service device 520, the security service device 525, or another network node. Thus, the security service device 505 may provide scalable attestation (or more precisely the attestation result of a device or a service) across multiple PLMNs, such as an hPLMN and a vPLMN, thereby reducing the occurrence of the difficulties described above. In some aspects, this attestation may be performed in addition to (e.g., in connection with) authentication, providing a reduced attestation and verification overhead relative to performing attestation separately from authentication. Furthermore, aspects described herein provide semi-dynamic or dynamic attestation, as well as mutual attestation. Semi-dynamic attestation may provide scalability by allowing the security service device 505 to provide an attestation result previously obtained by the security service device 505 for a length of time, thereby reducing signaling overhead. Dynamic attestation may support various use cases such as mutual attestation, increasing the flexibility of network operation and attestation.

As shown by reference number 530, the device 510 (or a network node) may provide attestation information to the security service device 505. The attestation information may include a verifiable claim, such as known safe state information. In some aspects, the attestation information may include an entity attestation token. As shown by reference number 535, the security service device 505 may generate an attestation result for the device 510 (or the network node). As shown by reference number 540, the security service device 505 may provide the attestation result (or information derived from or related to the attestation result) to the horizontal service device 515, the vertical service device 520, or the security service device 525. As shown by reference number 545, the device 510 (or the network node) may communicate with the horizontal service device 515, the vertical service device 520, or the security service device 525. These operations are described in more detail elsewhere herein. In some examples, the signaling of example 500 (and of examples 600, 700, 800, and 900 below) may be performed in accordance with a protocol such as a remote attestation protocol.

As previously described, at reference number 535, the security service device 505 may generate (e.g., identify, determine) the attestation result. For example, the security service device 505 may verify claims of the device 510 using a verification key (which may be associated with a reference value). The claims may include, for example, information indicating a location, a UE identifier, hardware model information, a hardware version, a software version, measurement information, information regarding one or more sub-modules, or the like. The verification key and/or the reference value may indicate specified values of the claims. If the specified values are met or otherwise satisfied by the claims, the security service device 505 may generate a successful attestation result. An attestation result may be the evaluation of an attestation (a set of claims) against the appraisal policy (e.g., success, fail) or may further include a set of claims required by the security service device 505 or another entity for evaluating the attestation against its service-specific appraisal policy. In some other aspects, another entity (such as a verifier separate from the security service device 505, which may be a trusted entity such as a manufacturer) may generate the attestation result.

Thus, the network (such as the horizontal service device 525, the vertical service device 520, or the security service device 525) can verify a UE and states of operation of the UE. In this way, the risks of compromised UEs are reduced, the risks of gray devices are reduced, and issues associated with only using subscription authentication are mitigated (thereby reducing the viability of SIM boxes and fake IMEIs). Furthermore, the attestation can be performed (e.g., piggybacked) in connection with an authentication procedure, or can be run independently as desired. Furthermore, the UE can verify the network (such as a gNB, DU, or RU), thereby reducing the risk of encountering a fake base station.

As indicated above, FIG. 5 is provided as an example. Other examples may differ from what is described with regard to FIG. 5.

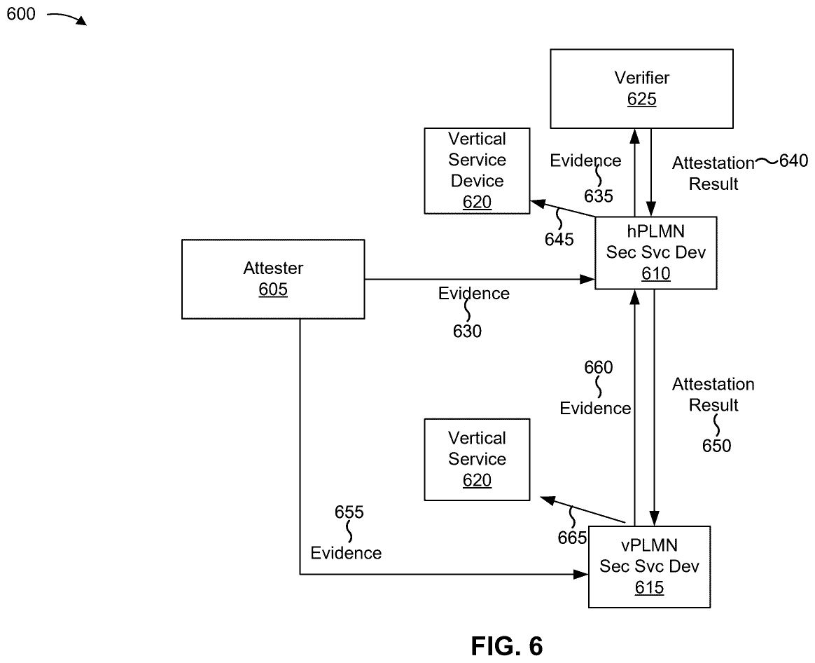

FIG. 6 is a diagram illustrating an example 600 of signaling associated with remote attestation to establish trust in a wireless network, in accordance with aspects of the present disclosure. Example 600 includes an attester device 605 (such as a UE 120 or a network node 110), a first security service device 610 (such as a security service device 505 or a security service device 415b), a second security service device 615 (such as a security service device 525 or a security service device 415b), vertical service devices 620 (such as vertical service device 425 or vertical service device 520), and a verifier 625. In example 600, the verifier 625 is separate from the security service device 610/615. For example, the verifier 625 may be a vendor associated with the attester device 605 (e.g., a UE vendor, a network node vendor, or the like). In some other aspects, the first security service device 610 or the second security service device 615 may be the verifier 625 (such as according to an appraisal policy for evidence, e.g., appraisal policy for evidence 950, described below).

An appraisal policy for evidence may indicate information to be included in the evidence for a given service. For example, the appraisal policy for evidence may indicate one or more claims to be included in the evidence, such as a location, a UE identifier, hardware model information, a hardware version, a software version, measurement information, information regarding one or more sub-modules, or the like. As one example, a first service may request a first set of claims including a location, a UE identifier, and measurement information from a UE for attestation, and a vertical service may request a second set of claims including a UE identifier, a hardware model, and a hardware version from the UE for attestation. A first appraisal policy for evidence, corresponding to the first service, may indicate the first set of claims, and a second appraisal policy for evidence, corresponding to the vertical service, may indicate the second set of claims.

As shown by reference number 630, the attester device 605 may provide evidence to the first security service device 610. As shown by reference number 635, the first security service device 610 may provide the evidence to the verifier 625. As shown by reference number 640, the verifier 625 may provide an attestation result to the first security service device 610. As shown by reference number 645, the first security service device 610 may provide the attestation result to a vertical service device 620. Additionally, or alternatively, shown by reference number 650, the first security service device 610 may provide the attestation result to the second security service device 615. The attestation result may be the evaluation of attestation against the appraisal policy (e.g., success, fail) or may further include a set of claims required by the service for evaluating the attestation against its service specific appraisal policy.

In some aspects, as shown by reference number 655, the attester device 605 may provide the evidence to the second security service device 615. For example, the attester device 605 may provide the evidence to the second security service device 615 in connection with roaming on a network (a vPLMN) of the second security service device 615. In this example, as shown by reference number 660, the second security service device 615 may provide the evidence (or information derived from the evidence) to the first security service device 610. For example, the second security service device 615 may provide the evidence to the first security service device 610 based at least in part on the first security service device 610 being associated with a hPLMN of the attester device 605. The first security service device 610 may provide the evidence to the verifier 625, as described with regard to reference number 635, and may receive an attestation result as described with regard to reference number 640. The first security service device 610 may provide the attestation result to the second security service device 615, as described with regard to reference number 650. The second security service device 615 may provide the attestation result to a vertical service device 620 (such as a vertical service associated with the vPLMN), as shown by reference number 665.

As indicated above, FIG. 6 is provided as an example. Other examples may differ from what is described with regard to FIG. 6.

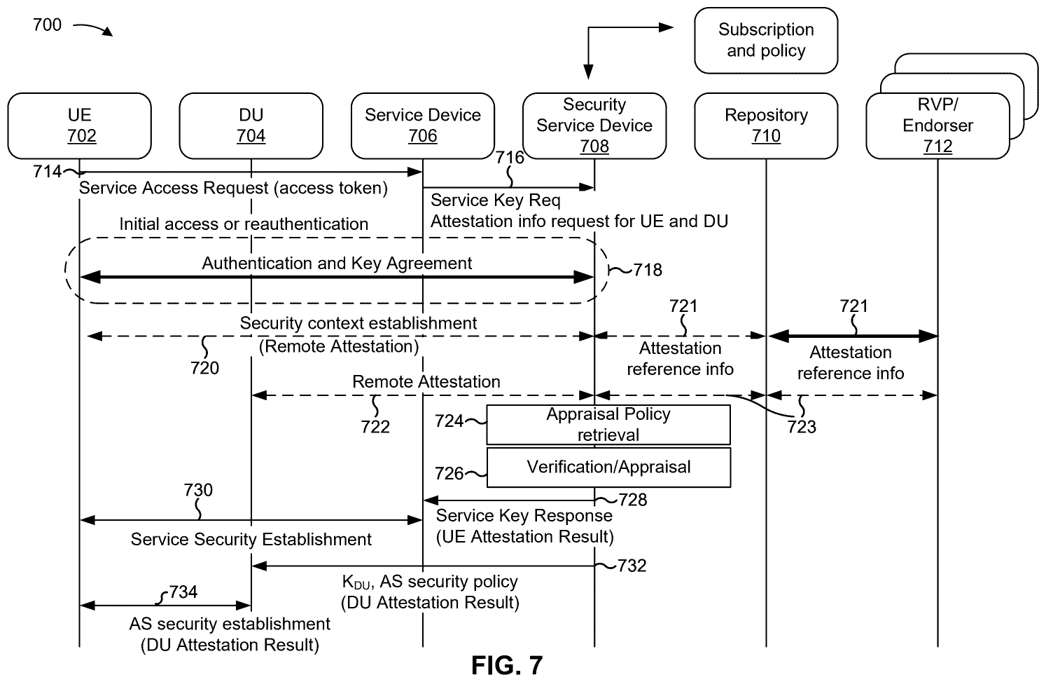

FIG. 7 is a diagram illustrating an example 700 of signaling associated with remote trust in a wireless network, in accordance with the present disclosure. Example 700 includes a device 702 (e.g., UE 120, device 405, device 510, attester device 605), a DU 704 (e.g., network node 110, DU 330, RAN 410, device 510, attester device 605), a service device 706 (e.g., network node 110, vertical service device 425, vertical service device 525, vertical service device 620), a security service device 708 (e.g., network node 110, security service device 415b, security service device 505, first security service device 610, second security service device 615), a repository 710, and a reference value provider (RVP)/endorser 712 (e.g., reference value provider 930 and/or endorser 935). The repository 710 may include an entity that stores values related to remote attestation, such as a reference value from the RVP/endorser 712 or an endorsement from the RVP/endorser 712, among other examples. In some aspects, the repository 710 may be or include a unified data repository (UDR). As shown, the security service device 708 may access information regarding subscriptions (e.g., associated with SIMs) and policies (e.g., security policies, appraisal policies, etc.), such as via the repository 710.

As shown by reference number 714, the device 702 may transmit, and the service device 706 may receive, a service access request. The service access request may include a request for the device 702 to access the service device 706, such as an application associated with the service device 706. As shown, the service access request may include an access token. The access token may include information related to requesting access to the service device 706, such as a credential associated with the device 702 and/or the service device 706. In some aspects, the service access request may include a DU identifier corresponding to the DU 704.

In some aspects, the device 702 may request an attestation result for the DU 704 and/or the service device 706. For example, the device 702 may request the attestation result in connection with the service access request (e.g., during or as a part of the service access request, such as by including a DU identifier of the DU 704 in the service access request). As another example, the device 702 may request the attestation result prior to access stratum (AS) security setup (for example, the UE 120 may request the service attestation result before AS security setup when requesting the DU attestation result). As another example, the device 702 may request the attestation result periodically (e.g., according to a periodicity). As another example, the device 702 may request the attestation result “on demand,” such as in response to a trigger from another device or according to a criterion at the device 702.

As shown by reference number 716, the service device 706 may transmit a service key request to the security service device 708. The service key request may request a security key for the service device 706, such as for a security context between the device 702 and the service device 706. As shown, in some aspects, the service key request may include or be associated with an attestation information request for the device 702 and/or the DU 704. The service device 706 may request, from the security service device 708, an attestation result for the device 702 and/or an attestation result for the DU 706. For example, the service device 706 may represent a relying party of a remote attestation (RATS) architecture, as described below. In some aspects, the service device 706 may request the attestation result for the device 702 during service security establishment, as described below. In some other aspects, the service device 706 may request the attestation result periodically (e.g., according to a periodicity). As another example, the service device 706 may request the attestation result “on demand,” such as in response to a trigger from another device or according to a criterion at the service device 706. In some aspects, the request for the attestation result may include one or more appraisal requirements, such as an appraisal policy, an indication of a set of claims to be included in evidence provided by the device 702 or the DU 704.

As shown by reference number 718, two or more of the device 702, the DU 704, the service device 706, and/or the security service device 708 may perform authentication and key agreement. Authentication may include obtaining an authentication parameter from the device 702, the DU 704 and/or the service device 706 and verifying the authentication parameter against an authentication policy. Key agreement may include signaling to establish a security key to be used by the device 702, the DU 704, and/or the service device 706 for establishment of service security, as described below. For example, the authentication may include proof of device identity based on device credentials, such as a universal integrated circuit card (UICC) (e.g., an embedded UICC (cUICC) or an integrated UICC (iUICC) credential).

As shown by reference number 720, the device 702 and the security service device 708 may perform security context establishment. Security context establishment may include establishing a security context between the device 702 and the security service device 708. The information obtained from the security service device 708 may include, for example, a security key, information defining the security context, or the like. In some aspects, as shown, the security service device 708 may obtain attestation information of the device 702 (shown as “remote attestation” between the device 702 and the security service device 708). For example, the security service device 708 may request (e.g., trigger) attestation information to be provided by the device 702. In some aspects, the request for the attestation information may indicate a set of claims to be included in the attestation information (that is, the evidence), such as in accordance with an appraisal requirement of the service device 706. In some aspects, the security service device 708 may additionally or alternatively obtain attestation reference information 721 from the repository 710 and/or the RVP/endorser 712 in connection with the security context establishment. For example, this attestation reference information 721 may include one or more reference values, one or more endorsements, or a combination thereof.

As shown by reference number 722, in some examples, the security service device 708 may obtain attestation information from the DU 704 and/or the service device 706. For example, the security service device 708 may request (e.g., trigger) the attestation information to be provided by the DU 704 or the service device 706. For example, the security service device 708 may request the attestation information in connection with remote attestation of the DU 704. In some aspects, the request for the attestation information may indicate a set of claims to be included in the attestation information (that is, the evidence), such as in accordance with an appraisal requirement of the device 702. In some aspects, the security service device 708 may additionally or alternatively obtain attestation reference information 723 from the repository 710 and/or the RVP/endorser 712 in connection with the remote attestation shown by reference number 722. For example, this attestation reference information 723 may include one or more reference values, one or more endorsements, or a combination thereof.

As shown by reference number 724, in some aspects, the security service device 708 may obtain an appraisal policy for evidence. For example, the appraisal policy for evidence may relate the service device 706 and/or the device 702, as described with regard to FIG. 6.

As shown by reference number 726, the security service device 708 may perform verification (e.g., in connection with authentication of the device 702 and/or the DU 704) and/or appraisal. The appraisal may include appraisal of attestation information to determine an attestation result, or may include retrieving the attestation result (for example, if the security service device 708 has previously stored an attestation result for the corresponding attester device). Thus, the security service device 708 may perform appraisal of an attestation. An attestation result corresponding to the appraisal may be stored at the security service device 708, along with evidence (e.g., set of claims). Thus the security service device 708 may avoid frequent attestation triggering, as described above. In some aspects, the security device 708 may provide the attestation result and/or the evidence to service devices (e.g., service device 706), a DU (e.g., DU 704), or a device (e.g., a UE such as the device 702), such as a service device that requested the attestation result, without performing a separate attestation.

Further description of appraisal (generation or retrieval of attestation results) are provided for the device 702, the DU 704, and the service device 706, below.

In some aspects, the security service device 708 may obtain (e.g., retrieve) an attestation result of the device 702. In this example, the security service device 708 may determine the attestation result using attestation information provided by the device 702. As another example, the security service device 708 may retrieve the attestation result from another entity, such as the repository 710. If a previous attestation result for the device 702 is available (e.g., has not expired), the security service device 708 may provide the previous attestation result to the service device 706 and/or the device 702.

In some aspects, the security service device 708 may generate the attestation result. For example, the security service device 708 may trigger attestation and, based on the attestation, may generate the attestation result if a previous attestation result for the device 702 is not available. As another example, the security service device 708 may generate the attestation result (which may include triggering attestation) if an appraisal requirement of an entity requesting the attestation information (such as the service device 706) is not met by the previous attestation result. As another example, the security service device 708 may generate the attestation result (which may include triggering attestation) if the service device 706 has requested an updated (e.g., fresh) attestation result for the device 702. In some aspects, the security service device 708 may generate the attestation result for the device 702 using attestation reference information such as a reference value and/or endorsement obtained from the repository 710 and/or the RVP/endorser 712, as described elsewhere herein.

In some aspects, the security service device 708 may obtain (e.g., retrieve) an attestation result of the DU 704 and/or the service device 706. For example, the security service device 708 may determine the attestation result using attestation information provided by the DU 704 and/or the service device 706. As another example, the security service device 708 may retrieve the attestation result from another entity, such as the repository 710. If a previous attestation result for the DU 704 and/or 706 is available (e.g., has not expired), the security service device 708 may provide the previous attestation result to the device 702 and/or the service device 706.

In some aspects, the security service device 708 may generate the attestation result. For example, the security service device 708 may trigger attestation and, based on the attestation, may generate the attestation result if a previous attestation result for the DU 704 and/or service device 706 is not available. As another example, the security service device 708 may generate the attestation result (which may include triggering attestation) periodically (such as according to a network policy). As another example, the security service device 708 may generate the attestation result (which may include triggering attestation) if an appraisal requirement of an entity requesting the attestation information (such as the device 702 or the service device 706) is not met by the previous attestation result. As another example, the security service device 708 may generate the attestation result (which may include triggering attestation) if the device 702 or the service device 706 has requested an updated (e.g., fresh) attestation result for the service device 706 or the DU 704. In some aspects, the security service device 708 may generate the attestation result for the DU 704 or the service device 706 using attestation information, which may include a reference value and/or endorsement obtained from the repository 710 and/or the RVP/endorser 712, as described elsewhere herein.

In some aspects, the DU 704 or the service device 706 may be implemented (e.g., instantiated) on a cloud platform. In this example, attestation may relate to the cloud platform. A service device 706 or DU 704 instantiated on a cloud platform for which attestation information is provided may provide a binding to the cloud platform. Thus, attestation can be provided for cloud-implemented services, such as virtualized network functions, cloud-native network functions, or physical network functions (which may include, for example, a DU or an RU).

As shown by reference number 728, the security service device 708 may provide, to the service device 706, a service key response. The service key response may indicate a security key for communication between the device 702 and the service device 706. As further shown, in some aspects, the security service device 708 may provide an attestation result for the device 702 to the service device 706. For example, the security service device 708 may provide the attestation result with the service key response. As another example, the security service device 708 may provide the attestation result separately from the service key response.

As shown by reference number 730, the device 702 and the service device 706 may perform service security establishment. For example, the device 702 and the service device 706 may establish a secure connection, such as using security keys provided by the security service device 708. In some aspects, the device 702 and/or the service device 706 may perform service security establishment based at least in part on the attestation result of the device 702. For example, the service device 706 may perform service security establishment in response to an attestation result indicating that a state of the device 702 conforms to a corresponding appraisal policy.

As shown by reference number 732, the security service device 708 may provide, to the DU 704, a security key (Kpc) for the DU 704 and/or an AS security policy. The security key for the DU 704 and the AS security policy may be for AS security between the DU 704 and the device 702. As further shown, in some aspects, the security service device 708 may provide, to the DU 704, an attestation result for the DU 704. In some aspects, the security key for the DU 704 may be based at least in part on the attestation result. For example, the attestation result may be an input for generation of the security key.

As shown by reference number 734, the DU 704 may provide the attestation result for the DU 704 to the device 702 (such as in an AS security mode command). Furthermore, the DU 704 and the device 702 may perform AS security establishment. For example, the device 702 may establish AS security with the DU 704 in response to the attestation result of the DU 704 indicating that a state of the DU 704 conforms to a corresponding appraisal policy. In some aspects, the security service device 708 may provide the attestation result for the DU 704 to the service device 706, and the service device 706 may provide the attestation result to the device 702. In some aspects, the device 702 may generate a key, corresponding to the security key for the DU 704, using the attestation result. For example, the attestation result may be an input for generation of the security key at the device 702. In this way, any manipulation of the attestation results may lead to security establishment failure (e.g., AS security mode command failure).

As indicated above, FIG. 7 is provided as an example. Other examples may differ from what is described with regard to FIG. 7.

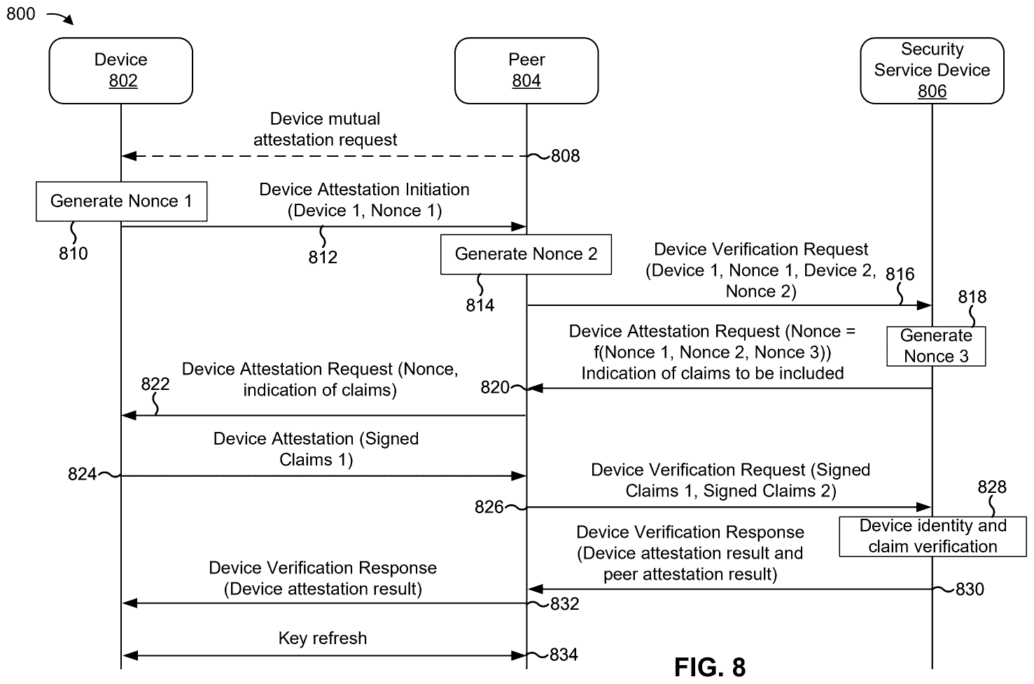

FIG. 8 is a diagram illustrating an example 800 of on-demand mutual attestation, in accordance with the present disclosure. Example 800 includes a device 802 (e.g., a device 405 or 510, an attester device 605, a device 702, a DU 704, or a service device 706), a peer 804 (such as a UE 120, a network node 110, a DU, or a service), and a security service device 806 (e.g., network node 110, security service device 415b, security service device 505, first security service device 610, second security service device 615, security service device 708). In on-demand mutual attestation, the device 802 and the peer 804 both provide attestation information, an attestation result for the device 802 is provided to the peer 804, and an attestation result for the peer 804 is provided to the device 802. It should be noted that mutual attestation, as described in connection with FIG. 8, can be performed periodically, in accordance with a configuration, or the like (that is, the mutual attestation does not need to be performed in response to a trigger or in an on-demand fashion).

As shown by reference number 808, in some examples, the peer 804 may transmit, and the device 802 may receive, a device mutual attestation request. The device mutual attestation request may request that the device 802 initiate or provide information in connection with a remote attestation procedure, which is described elsewhere herein. As shown by reference number 810, the device 802 may generate a first cryptographic nonce (Nonce 1). A cryptographic nonce may include an arbitrary value that is generated for use in a communication. In some aspects, a cryptographic nonce is generated for only a single use (to protect against replay attacks or other disruptions). As shown by reference number 812, the device 802 may provide a device attestation initiation message to the peer 804, and the device attestation initiation message may indicate the first cryptographic nonce and an identifier of the device 802.

As shown by reference number 814, the peer 804 may generate a second cryptographic nonce (Nonce 2). As shown by reference number 816, the peer 804 may provide, to the security service device 806, a device verification request. As shown, the device verification request may include the first cryptographic nonce, the identifier of the device 802, the second cryptographic nonce, and an identifier of the peer 804.

As shown by reference number 818, the security service device 806 may generate a third cryptographic nonce. As shown by reference number 820, the security service device 806 may transmit a device attestation request to the peer 804. The device attestation request may include a fourth cryptographic nonce that is a function of the first cryptographic nonce, the second cryptographic nonce, and the third cryptographic nonce. As further shown, the device attestation request may indicate a set of claims (e.g., evidence) to be included in attestation information of the peer 804 and/or the device 802.

As shown by reference number 822, the peer 804 may transmit, to the device 802, a device attestation request. The device attestation request may include the fourth cryptographic nonce and may indicate a set of claims to be included in attestation information of the device 802. As shown by reference number 824, the device 802 may transmit, and the peer 804 may receive, attestation information (shown as a device attestation). The attestation information may include the set of claims indicated by the device attestation request. In some aspects, the set of claims may be signed by the device 802. For example, the device 802 may sign the set of claims using the identifier of the peer 804. In some aspects, the signed set of claims may be encrypted using a public key or shared key of the security service device 806, thereby enabling privacy of the signed set of claims.

As shown by reference number 826, the peer 804 may transmit, to the security service device 806, a device verification request. As show, the device verification request may include the signed set of claims provided by the device 802. Furthermore, the device verification request may include a set of claims provided by the peer 804. In some aspects, the set of claims provided by the peer 804 may be signed by the peer 804. For example, the peer 804 may sign the set of claims using the identifier of the UE 802. In some aspects, the signed set of claims may be encrypted using a public key or shared key of the security service device 806, thereby enabling privacy of the signed set of claims.

As shown by reference number 828, the security service device 806 may perform verification of an identity of the UE 802 and/or the peer 804 (for example, the security service device 806 may perform authentication). Furthermore, the security service device 806 may verify the sets of claims provided by the device 802 and the peer 804, such as according to one or more appraisal policies as described elsewhere herein, thereby generating an attestation result for the device 802 and the peer 804. As shown by reference number 830, the security service device may provide a device verification response to the peer 804. The device verification response may indicate the attestation result for the device 802, the attestation result for the peer 804, and optionally a certificate associated with the security service device 806. In some examples, the attestation result for the device 802 (and optionally the corresponding appraisal policy) may be encrypted (e.g., protected) using a security key shared by the device 802 with the security service device 806, or may be signed by the security service device 806. In some examples, the attestation result for the peer 804 (and optionally the corresponding appraisal policy) may be encrypted (e.g., protected) using a security key shared by the peer 804 with the security service device 806, or may be signed by the security service device 806.

As shown by reference number 832, the peer 804 may provide a device verification response to the device 802. The device verification response may indicate the attestation result for the peer 804. As shown by reference number 834, the device 802 may perform a key refresh with the peer 804. For example, the device 802 and the peer 804 may generate or derive a security key for communications between the device 802 and the peer 804 using the attestation result for the peer 804 and the device 802.

As indicated above, FIG. 8 is provided as an example. Other examples may differ from what is described with regard to FIG. 8.

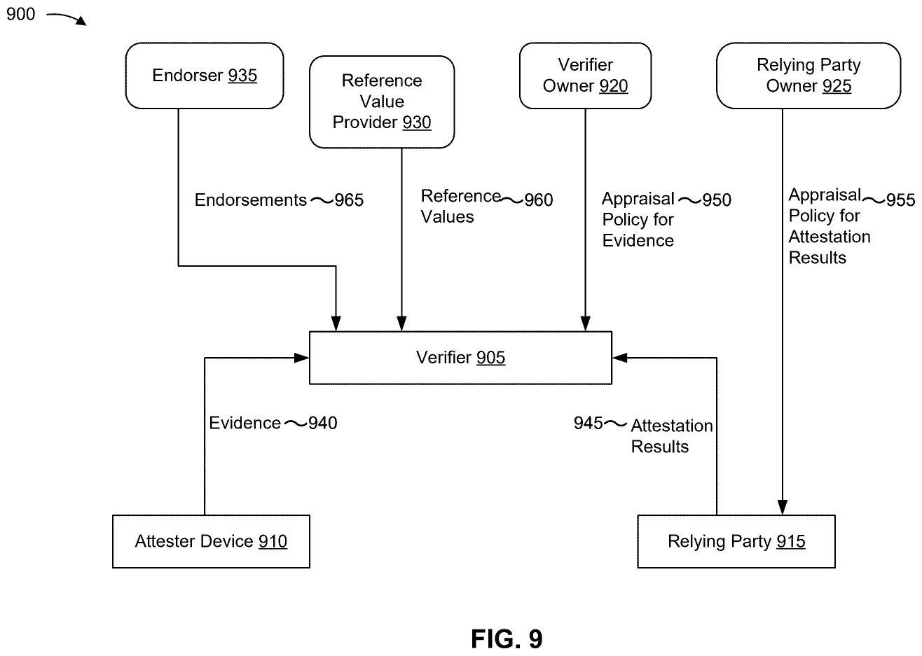

FIG. 9 is a diagram illustrating an example 900 of a RATS architecture, in accordance with the present disclosure. Example 900 includes a verifier 905 (e.g., a security service device described above), an attester device 910 (e.g., a device 405 or 510, an attester device 605, a device 702, a DU 704, or a service device 706), a relying party 915 (e.g., a security service device as described above, a horizontal service, or a vertical service), a verifier owner 920, a relying party owner 925, a reference value provider 930 (e.g., RVP/endorser 712), and an endorser 935 (e.g., RVP/endorser 712). Information exchanged in example 900 may include evidence 940, attestation results 945, an appraisal policy for evidence 950, an appraisal policy for attestation results 955, reference values 960, and endorsements 965. The RATs architecture provides for a device (such as a relying party 915 or verifier 905) to verify that an attester device 910 is in an intended operating state through a process of generating, conveying, and evaluating evidentiary claims.

The verifier 905 may include an entity that appraises the validity of evidence 940 and generates attestation results 945 based on appraising the validity of evidence 940. The evidence 940 may include a set of claims generated by an attester device 910, such as configuration data, measurements, telemetry, or inferences. A claim may include a piece of information asserted about a subject. The attestation results 945 may include an output generated by the verifier 905. The attester device 910 may include an entity whose evidence 940 is appraised by the verifier 905. In some aspects, the evidence 940 may include an entity attestation token (EAT). An EAT may include a message (e.g., an encoded message) that transfers a set of claims between two parties. An EAT may include authenticity and integrity protection.

The relying party 915 may include an entity that performs application-specific actions based on the validity of information regarding the attester device 910 (that is, the attestation results 945).

The verification owner 920 may include an entity, such as an administrator, that is authorized to configure an appraisal policy for evidence 950. The appraisal policy for evidence 950 may include a set of rules used to evaluate the validity of the attester device 910's information (that is, the evidence 940).

The relying party owner 925 may include an entity, such as an administrator, that is authorized to configure an appraisal policy for attestation results 955. The appraisal policy for attestation results 955 may indicate a set of rules direction how the relying party 915 uses the attestation results 945.

The reference value provider 930 may include an entity, such as a manufacturer, that can provide reference values 960 used to appraise the evidence. The reference values 960 may include a set of values to which values of the claims of the evidence 940 can be compared.

The endorser 935 may include an entity, such as a manufacturer, that may provide an endorsement 965 used to appraise the authenticity of the evidence. The endorsement 965 may include a secure statement that the endorser 935 vouches for the integrity of the attester device 910's capabilities.

As indicated above, FIG. 9 is provided as an example. Other examples may differ from what is described with regard to FIG. 9.

FIG. 10 is a diagram illustrating an example process 1000 performed, for example, at a security service device or an apparatus of a security service device, in accordance with the present disclosure. Example process 1000 is an example where the apparatus or the security service device (e.g., verifier 905, security service device 806, network node 110, security service device 415b, security service device 505, first security service device 610, second security service device 615, security service device 708) performs operations associated with trust establishment in wireless networks.

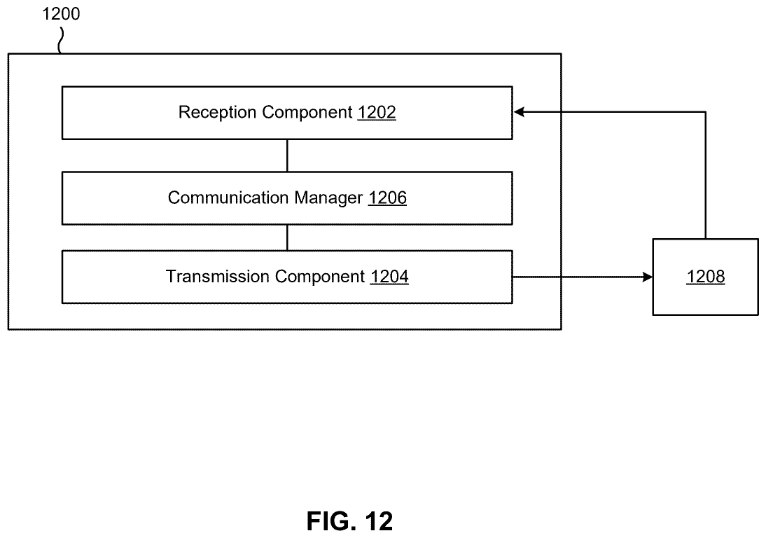

As shown in FIG. 10, in some aspects, process 1000 may include receiving, from at least one of a device or a service, attestation information that includes verifiable information regarding a state of the device or a state of the service (block 1010). For example, the security service device (e.g., using reception component 1202 and/or communication manager 1206, depicted in FIG. 12) may receive, from at least one of a device or a service, attestation information that includes verifiable information regarding a state of the device or a state of the service, as described above.

As further shown in FIG. 10, in some aspects, process 1000 may include generating an attestation result indicating whether the attestation information satisfies an appraisal condition (block 1020). For example, the security service device (e.g., using communication manager 1206, depicted in FIG. 12) may generate an attestation result indicating whether the attestation information satisfies an appraisal condition, as described above.

As further shown in FIG. 10, in some aspects, process 1000 may include receiving a request for the attestation result (block 1030). For example, the security service device (e.g., using reception component 1202 and/or communication manager 1206, depicted in FIG. 12) may receive a request for the attestation result, as described above.

As further shown in FIG. 10, in some aspects, process 1000 may include providing the attestation result in accordance with the request (block 1040). For example, the security service device (e.g., using communication manager 1206, depicted in FIG. 12) may provide the attestation result in accordance with the request, as described above.

Process 1000 may include additional aspects, such as any single aspect or any combination of aspects described below and/or in connection with one or more other processes described elsewhere herein.

In a first aspect, process 1000 includes requesting the attestation information prior to receiving the attestation information.

In a second aspect, alone or in combination with the first aspect, process 1000 includes requesting the attestation information in accordance with the attestation initiation message.

In a third aspect, alone or in combination with one or more of the first and second aspects, the attestation information indicates the state of the device and the attestation initiation message is from the service.

In a fourth aspect, alone or in combination with one or more of the first through third aspects, the attestation information indicates the state of the service and the attestation initiation message is from the device.

In a fifth aspect, alone or in combination with one or more of the first through fourth aspects, the attestation initiation message includes a first value generated by the device and a second value generated by the service.

In a sixth aspect, alone or in combination with one or more of the first through fifth aspects, the first value is a first cryptographic nonce and the second value is a second cryptographic nonce.

In a seventh aspect, alone or in combination with one or more of the first through sixth aspects, requesting the attestation information further comprises requesting the attestation information in accordance with a previous attestation result having expired.

In an eighth aspect, alone or in combination with one or more of the first through seventh aspects, requesting the attestation information further comprises requesting the attestation information in association with a service access request of the device.

In a ninth aspect, alone or in combination with one or more of the first through eighth aspects, requesting the attestation information further comprises requesting the attestation information in accordance with a periodicity.

In a tenth aspect, alone or in combination with one or more of the first through ninth aspects, a request for the attestation information indicates the attestation information to be provided.

In an eleventh aspect, alone or in combination with one or more of the first through tenth aspects, receiving the attestation information further comprises receiving the attestation information from the device and the service, wherein the attestation result includes a first attestation result for the device and a second attestation result for the service.

In a twelfth aspect, alone or in combination with one or more of the first through eleventh aspects, receiving the attestation information further comprises receiving the attestation information from the service, wherein the attestation information indicates the state of the device.

In a thirteenth aspect, alone or in combination with one or more of the first through twelfth aspects, the service is accessed by the device.

In a fourteenth aspect, alone or in combination with one or more of the first through thirteenth aspects, the attestation information includes at least one of location information, a user equipment identifier, a service identifier, hardware model information, version information, software version information, information, or information regarding a sub-module of the UE or the service.

In a fifteenth aspect, alone or in combination with one or more of the first through fourteenth aspects, the service is associated with a cloud platform on which a service is instantiated, and wherein the attestation information relates to the cloud platform.

In a sixteenth aspect, alone or in combination with one or more of the first through fifteenth aspects, the service includes at least one of a virtualized network function, a cloud-native network function, or a physical network function.

In a seventeenth aspect, alone or in combination with one or more of the first through sixteenth aspects, providing the attestation result further comprises providing the attestation result in association with a key generation operation of the device or the service.

In an eighteenth aspect, alone or in combination with one or more of the first through seventeenth aspects, the security service device is a root of trust for attestation of the device or the service.

In a nineteenth aspect, alone or in combination with one or more of the first through eighteenth aspects, process 1000 includes receiving a device credential associated with the device or the service, and authenticating the device or the service using the device credential.

In a twentieth aspect, alone or in combination with one or more of the first through nineteenth aspects, the device credential comprises at least one of an integrated universal integrated circuit card (UICC) credential or an embedded UICC credential.

In a twenty-first aspect, alone or in combination with one or more of the first through twentieth aspects, providing the attestation result further comprises providing an appraisal policy, wherein the appraisal policy indicates the appraisal condition or one or more parameters of the attestation information.

In a twenty-second aspect, alone or in combination with one or more of the first through twenty-first aspects, the appraisal policy is specific to the service.

In a twenty-third aspect, alone or in combination with one or more of the first through twenty-second aspects, generating the attestation result further comprises verifying the verifiable information in accordance with a remote attestation operation or an entity attestation token operation.

In a twenty-fourth aspect, alone or in combination with one or more of the first through twenty-third aspects, the service is associated with a user equipment (UE).

In a twenty-fifth aspect, alone or in combination with one or more of the first through twenty-fourth aspects, the service is associated with a first public land mobile network (PLMN), the security service device is associated with a second PLMN, and providing the attestation result further comprises providing the attestation result to the service.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at an attester device or an apparatus of an attester device, in accordance with the present disclosure. Example process 1100 is an example where the apparatus or the attester device (e.g., a device 405 or 510, an attester device 605, a device 702, a DU 704, a service device 706, a device 802, a peer 804, an attester device 910) performs operations associated with trust establishment in wireless networks.

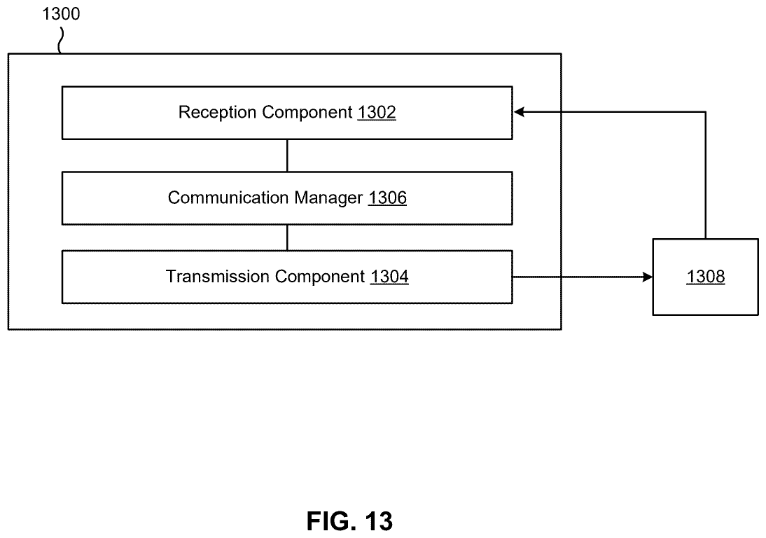

As shown in FIG. 11, in some aspects, process 1100 may include receiving, from a service, a request for attestation information that includes verifiable information regarding a state of the attester device (block 1110). For example, the attester device (e.g., using reception component 1302 and/or communication manager 1306, depicted in FIG. 13) may receive, from a service, a request for attestation information that includes verifiable information regarding a state of the attester device, as described above.

As further shown in FIG. 11, in some aspects, process 1100 may include transmitting the attestation information in accordance with the request (block 1120). For example, the attester device (e.g., using transmission component 1304 and/or communication manager 1306, depicted in FIG. 13) may transmit the attestation information in accordance with the request, as described above.

Process 1100 may include additional aspects, such as any single aspect or any combination of aspects described below and/or in connection with one or more other processes described elsewhere herein.

In a first aspect, the attester device is a user equipment.

In a second aspect, alone or in combination with the first aspect, the attester device is a network node (such as a service or a DU).

In a third aspect, alone or in combination with one or more of the first and second aspects, process 1100 includes transmitting, prior to transmitting the attestation information, a cryptographic nonce, wherein the request for the attestation information is based at least in part on the cryptographic nonce.

In a fourth aspect, alone or in combination with one or more of the first through third aspects, receiving the request for the attestation information further comprises receiving the request for the attestation information in accordance with a previous attestation result having expired.

In a fifth aspect, alone or in combination with one or more of the first through fourth aspects, receiving the request for the attestation information further comprises receiving the request for the attestation information in association with a service access request of a user equipment.

In a sixth aspect, alone or in combination with one or more of the first through fifth aspects, receiving the request for the attestation information further comprises receiving the request for the attestation information in accordance with a periodicity.

In a seventh aspect, alone or in combination with one or more of the first through sixth aspects, the request for the attestation information indicates the attestation information to be provided.

In an eighth aspect, alone or in combination with one or more of the first through seventh aspects, the attester device is a network node, and wherein the attestation information further indicates a state of a user equipment (UE) associated with the network node.

In a ninth aspect, alone or in combination with one or more of the first through eighth aspects, the network node is associated with a service or cell accessed by the UE.

In a tenth aspect, alone or in combination with one or more of the first through ninth aspects, the attestation information includes at least one of location information, a user equipment identifier, a service identifier, hardware model information, version information, software version information, information, or information regarding a sub-module of the attester device.

In an eleventh aspect, alone or in combination with one or more of the first through tenth aspects, the attester device is associated with a cloud platform on which a service is instantiated, and wherein the attestation information relates to the cloud platform.

In a twelfth aspect, alone or in combination with one or more of the first through eleventh aspects, the service includes at least one of a virtualized network function, a cloud-native network function, or a physical network function.

In a thirteenth aspect, alone or in combination with one or more of the first through twelfth aspects, the service comprises a security service device that is a root of trust for attestation of the attester device.

In a fourteenth aspect, alone or in combination with one or more of the first through thirteenth aspects, process 1100 includes transmitting a device credential for authentication associated with the attester device.

In a fifteenth aspect, alone or in combination with one or more of the first through fourteenth aspects, the device credential comprises at least one of an integrated universal integrated circuit card (UICC) credential or an embedded UICC credential.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a security service device, or a security service device may include the apparatus 1200. In some aspects, the apparatus 1200 includes a reception component 1202, a transmission component 1204, and/or a communication manager 1206, which may be in communication with one another (for example, via one or more buses and/or one or more other components). As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-9. Additionally, or alternatively, the apparatus 1200 may be configured to perform one or more processes described herein, such as process 1000 of FIG. 10, or a combination thereof. In some aspects, one or more components of the security service device may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the security service device.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from at least one of a device or a service, attestation information that includes verifiable information regarding a state of the device or a state of the service. The communication manager 1206 may generate an attestation result indicating whether the attestation information satisfies an appraisal condition. The reception component 1202 may receive a request for the attestation result. The communication manager 1206 may provide the attestation result in accordance with the request.

The communication manager 1206 may request the attestation information prior to receiving the attestation information.

The communication manager 1206 may request the attestation information in accordance with the attestation initiation message.

The reception component 1202 may receive a device credential associated with the device or the service.

The communication manager 1206 may authenticate the device or the service using the device credential.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be an attester device (such as a UE 120, a network node 110, a DU, an RU, or a service device 415/425), or a attester device may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 or 150 described in connection with FIG. 1. As shown, the apparatus 1300 may communicate with another apparatus 1308, such as a UE, a network node (such as a CU, a DU, an RU, or a base station), a service, or a security service device, using the reception component 1302 and the transmission component 1304.

In some aspects, the apparatus 1300 may be configured to perform one or more operations described herein in connection with FIGS. 4-9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the attester device described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the attester device described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the attester device described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, from a service, a request for attestation information that includes verifiable information regarding a state of the attester device. The transmission component 1304 may transmit the attestation information in accordance with the request.

The transmission component 1304 may transmit, prior to transmitting the attestation information, a cryptographic nonce, wherein the request for the attestation information is based at least in part on the cryptographic nonce.

The transmission component 1304 may transmit a device credential for authentication associated with the attester device.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a security service device, comprising: receiving, from at least one of a device or a service, attestation information that includes verifiable information regarding a state of the device or a state of the service; generating an attestation result indicating whether the attestation information satisfies an appraisal condition; receiving a request for the attestation result; and providing the attestation result in accordance with the request.

Aspect 2: The method of Aspect 1, further comprising requesting the attestation information prior to receiving the attestation information.

Aspect 3: The method of Aspect 2, further comprising receiving an attestation initiation message, wherein requesting the attestation information further comprises requesting the attestation information in accordance with the attestation initiation message.

Aspect 4: The method of Aspect 3, wherein the attestation information indicates the state of the device and the attestation initiation message is from the service.

Aspect 5: The method of Aspect 3, wherein the attestation information indicates the state of the service and the attestation initiation message is from the device.

Aspect 6: The method of Aspect 3, wherein the attestation initiation message includes a first value generated by the device and a second value generated by the service.

Aspect 7: The method of Aspect 6, wherein the first value is a first cryptographic nonce and the second value is a second cryptographic nonce.

Aspect 8: The method of Aspect 2, wherein requesting the attestation information further comprises requesting the attestation information in accordance with a previous attestation result having expired.

Aspect 9: The method of Aspect 2, wherein requesting the attestation information further comprises requesting the attestation information in association with a service access request of the device.

Aspect 10: The method of Aspect 2, wherein requesting the attestation information further comprises requesting the attestation information in accordance with a periodicity.

Aspect 11: The method of Aspect 2, wherein a request for the attestation information indicates the attestation information to be provided.

Aspect 12: The method of any of Aspects 1-11, wherein receiving the attestation information further comprises receiving the attestation information from the device and the service, wherein the attestation result includes a first attestation result for the device and a second attestation result for the service.

Aspect 13: The method of any of Aspects 1-12, wherein receiving the attestation information further comprises receiving the attestation information from the service, wherein the attestation information indicates the state of the service.

Aspect 14: The method of Aspect 13, wherein the service is accessed by the device.

Aspect 15: The method of any of Aspects 1-14, wherein the attestation information includes at least one of: location information, a user equipment identifier, a service identifier, hardware model information, hardware version information, software version information, measurement information, or information regarding a sub-module of the UE or the service.

Aspect 16: The method of any of Aspects 1-15, wherein the service is associated with a cloud platform on which a service is instantiated, and wherein the attestation information relates to the cloud platform.

Aspect 17: The method of Aspect 16, wherein the service includes at least one of: a virtualized network function, a cloud-native network function, or a physical network function.

Aspect 18: The method of any of Aspects 1-17, wherein providing the attestation result further comprises providing the attestation result in association with a key generation operation of the device or the service.

Aspect 19: The method of any of Aspects 1-18, wherein the security service device is a root of trust for attestation of the device or the service.

Aspect 20: The method of any of Aspects 1-19, further comprising: receiving a device credential associated with the device or the service; and authenticating the device or the service using the device credential.

Aspect 21: The method of Aspect 20, wherein the device credential comprises at least one of an integrated universal integrated circuit card (UICC) credential or an embedded UICC credential.

Aspect 22: The method of any of Aspects 1-21, wherein providing the attestation result further comprises providing an appraisal policy, wherein the appraisal policy indicates the appraisal condition or one or more parameters of the attestation information.

Aspect 23: The method of Aspect 22, wherein the appraisal policy is specific to the service.

Aspect 24: The method of any of Aspects 1-23, wherein generating the attestation result further comprises verifying the verifiable information in accordance with a remote attestation operation or an entity attestation token operation.

Aspect 25: The method of any of Aspects 1-24, wherein the service is associated with a user equipment (UE).

Aspect 26: The method of any of Aspects 1-25, wherein the service is associated with a first public land mobile network (PLMN), the security service device is associated with a second PLMN, and providing the attestation result further comprises providing the attestation result to the service.

Aspect 27: A method of wireless communication performed by an attester device, comprising: receiving, from a service, a request for attestation information that includes verifiable information regarding a state of the attester device; and transmitting the attestation information in accordance with the request.

Aspect 28: The method of Aspect 27, wherein the attester device is a user equipment.

Aspect 29: The method of any of Aspects 27-28, wherein the attester device is a network node.

Aspect 30: The method of any of Aspects 27-29, further comprising transmitting, prior to transmitting the attestation information, a cryptographic nonce, wherein the request for the attestation information is based at least in part on the cryptographic nonce.

Aspect 31: The method of any of Aspects 27-30, wherein receiving the request for the attestation information further comprises receiving the request for the attestation information in accordance with a previous attestation result having expired.

Aspect 32: The method of any of Aspects 27-31, wherein receiving the request for the attestation information further comprises receiving the request for the attestation information in association with a service access request of a user equipment.

Aspect 33: The method of any of Aspects 27-32, wherein receiving the request for the attestation information further comprises receiving the request for the attestation information in accordance with a periodicity.

Aspect 34: The method of any of Aspects 27-33, wherein the request for the attestation information indicates the attestation information to be provided.

Aspect 35: The method of any of Aspects 27-34, wherein the attester device is a network node, and wherein the attestation information further indicates a state of a user equipment (UE) associated with the network node.

Aspect 36: The method of Aspect 35, wherein the network node is associated with a service or cell accessed by the UE.

Aspect 37: The method of any of Aspects 27-36, wherein the attestation information includes at least one of: location information, a user equipment identifier, a service identifier, hardware model information, hardware version information, software version information, measurement information, or information regarding a sub-module of the attester device.

Aspect 38: The method of any of Aspects 27-37, wherein the attester device is associated with a cloud platform on which a service is instantiated, and wherein the attestation information relates to the cloud platform.

Aspect 39: The method of Aspect 38, wherein the service includes at least one of: a virtualized network function, a cloud-native network function, or a physical network function.

Aspect 40: The method of any of Aspects 27-39, wherein the service comprises a security service device that is a root of trust for attestation of the attester device.

Aspect 41: The method of any of Aspects 27-40, further comprising: transmitting a device credential for authentication associated with the attester device.

Aspect 42: The method of Aspect 41, wherein the device credential comprises at least one of an integrated universal integrated circuit card (UICC) credential or an embedded UICC credential.

Aspect 43: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-42.

Aspect 44: An apparatus for wireless communication at a device, the apparatus comprising one or more memories and one or more processors coupled to the one or more memories, the one or more processors configured to cause the device to perform the method of one or more of Aspects 1-42.

Aspect 45: An apparatus for wireless communication, the apparatus comprising at least one means for performing the method of one or more of Aspects 1-42.

Aspect 46: A non-transitory computer-readable medium storing code for wireless communication, the code comprising instructions executable by one or more processors to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

Aspect 48: A device for wireless communication, the device comprising a processing system that includes one or more processors and one or more memories coupled with the one or more processors, the processing system configured to cause the device to perform the method of one or more of Aspects 1-42.

Aspect 49: An apparatus for wireless communication at a device, the apparatus comprising one or more memories and one or more processors coupled to the one or more memories, the one or more processors individually or collectively configured to cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a security service device, comprising:
one or more memories; and
one or more processors, coupled to the one or more memories, configured to cause the security service device to:
receive, from at least one of a device or a service, attestation information that includes verifiable information regarding a state of the device or a state of the service;
generate an attestation result indicating whether the attestation information satisfies an appraisal condition;
receive a request for the attestation result; and
provide the attestation result in accordance with the request.

2. The apparatus of claim 1, wherein the one or more processors are further configured to cause the security service device to request the attestation information prior to receiving the attestation information.

3. The apparatus of claim 2, wherein the one or more processors are further configured to cause the security service device to receive an attestation initiation message, wherein, to cause the security service device to receive the attestation information, the one or more processors are configured to cause the security service device to request the attestation information in accordance with the attestation initiation message.

4. The apparatus of claim 3, wherein the attestation information indicates the state of the device and the attestation initiation message is from the service, or wherein the attestation information indicates the state of the service and the attestation initiation message is from the device.

5. The apparatus of claim 2, wherein the one or more processors, to cause the security service device to request the attestation information, are configured to cause the security service device to request the attestation information in accordance with a previous attestation result having expired.

6. The apparatus of claim 2, wherein the one or more processors, to cause the security service device to request the attestation information, are configured to cause the security service device to request the attestation information in association with a service access request of the device.

7. The apparatus of claim 1, wherein the one or more processors, to cause the security service device to receive the attestation information, are configured to cause the security service device to receive the attestation information from the device and the service, wherein the attestation result includes a first attestation result for the device and a second attestation result for the service.

8. The apparatus of claim 1, wherein the one or more processors, to cause the security service device to receive the attestation information, are configured to cause the security service device to receive the attestation information from the service, wherein the attestation information indicates the state of the service.

9. The apparatus of claim 1, wherein the one or more processors, to cause the security service device to provide the attestation result, are configured to cause the security service device to provide the attestation result in association with a key generation operation of the device or the service.

10. The apparatus of claim 1, wherein the one or more processors are configured to cause the security service device to:
receive a device credential associated with the device or the service; and
authenticate the device or the service using the device credential.

11. The apparatus of claim 1, wherein the one or more processors, to cause the security service device to generate the attestation result, are configured to cause the security service device to verify the verifiable information in accordance with a remote attestation operation or an entity attestation token operation.

12. The apparatus of claim 1, wherein the one or more processors are further configured to cause the security service device to provide the attestation result to the service.

13. An apparatus for wireless communication at an attester device, comprising:
one or more memories; and
one or more processors, coupled to the one or more memories, configured to cause the attester device to:
receive, from a service, a request for attestation information that includes verifiable information regarding a state of the attester device; and
transmit the attestation information in accordance with the request.

14. The apparatus of claim 13, wherein the one or more processors are further configured to cause the attester device to transmit, prior to transmitting the attestation information, a cryptographic nonce, wherein the request for the attestation information is based at least in part on the cryptographic nonce.

15. The apparatus of claim 13, wherein the one or more processors, to cause the attester device to receive the request for the attestation information, are configured to cause the attester device to receive the request for the attestation information in accordance with a previous attestation result having expired.

16. The apparatus of claim 13, wherein the one or more processors, to cause the attester device to receive the request for the attestation information, are configured to cause the attester device to receive the request for the attestation information in association with a service access request of a user equipment.

17. The apparatus of claim 13, wherein the one or more processors, to cause the attester device to receive the request for the attestation information, are configured to cause the attester device to receive the request for the attestation information in accordance with a periodicity.

18. The apparatus of claim 13, wherein the attester device is a network node, and wherein the attestation information further indicates a state of a user equipment (UE) associated with the network node.

19. The apparatus of claim 13, wherein the one or more processors are further configured to cause the attester device to:
transmit a device credential for authentication associated with the attester.

20. A method of wireless communication performed by a security service device, comprising:
receiving, from at least one of a device or a service, attestation information that includes verifiable information regarding a state of the device or a state of the service;
generating an attestation result indicating whether the attestation information satisfies an appraisal condition;
receiving a request for the attestation result; and
providing the attestation result in accordance with the request.
